(19) United States
(12) Patent Application Publication
(10) Pub. No.: US 2021/0024163 A1
(43) Pub. Date: Jan. 28, 2021

(54) KICK SCOOTER AND METHOD FOR OPERATING A SCOOTER

(71) Applicant: AUDI AG, Ingolstadt (DE)

(72) Inventors: Thorsten SCHRADER, Ingolstadt (DE); Lukas DÖNZ, München (DE)

(73) Assignee: AUDI AG, Ingolstadt (DE)

(21) Appl. No.: 16/757,664

(22) PCT Filed: Mar. 7, 2019
(86) PCT No.: PCT/EP2019/055683

§ 371 Date: Apr. 20, 2020

(30) Foreign Application Priority Data
Apr. 18, 2018 (DE) 10 2018 205 864.4

(51) Int. Cl. B62K 3/00; B62K 15/00

(52) U.S. Cl. CPC B62K 3/002; B62K 15/006

(57) ABSTRACT

The disclosure relates to a scooter having a deck. A front axle has at least one front wheel and a rear axle has at least one rear wheel. A steering column is used to transmit a steering motion to the at least one front wheel and an actuation element arranged on the steering column is used to release a locking device. When the locking device is released, the scooter can be brought into a stowing position. In the stowing position of the scooter, the rear axle together with the deck is moved toward the steering column about an axis of rotation and a distance between the rear axle and the front axle is equal to a distance between the rear axle and the front axle in a functional position of the scooter. The disclosure further relates to a method for operating a scooter of this type.

### TECHNICAL FIELD

The disclosure relates to a scooter.

### BACKGROUND

DE 10 2013 003 484 A1 describes a collapsible scooter with an electric drive motor. The scooter has a locking element for locking a folding joint in a state of use of the scooter and in a collapsed state of the scooter, which is connected to a release lever via a Bowden cable. The release lever is arranged on a bar of the scooter.

DE 102 04 478 A1 describes a scooter which comprises a handlebar unit, a front part with two front wheels and a rear part with one rear wheel. An unlocking lever is arranged on the handlebar unit. If the unlocking lever is moved downwards, an unlocking of the handlebar unit opposite the front part is achieved. At the same time an unlocking between the front part and rear part is created. A flexible spring then pivots the rear part about an axis towards the front part. In this way, the scooter can be converted from a scooter state to a caddy state. In the caddy state, the front part and the rear part are inclined towards the ground and against each other and they are supported on the ground by their wheels.

Such a scooter is relatively expensive due to the provision of the front part with the front wheels and the rear part with the rear wheel separate from the front part.

In addition, scooters with a front wheel and a rear wheel are commercially available, which can be folded or collapsed to facilitate transport in a motor vehicle or means of public transport. The collapsing of such a scooter also ensures that the space required to store the scooter at home by the user of the scooter is reduced. A collapsing mechanism to be actuated for collapsing is usually arrested near the front wheel of the scooter. After unlocking the collapsing mechanism, a deck of the scooter can be pivoted around an axis of rotation and folded up towards the handlebar. It is advantageous if the axis of rotation is as close as possible to the front wheel.

A disadvantage of such a scooter is the fact that the clamping mechanism or unlocking mechanism can only be operated when the user of the scooter bends down. In addition, both hands are required in such a scooter with a front wheel and a rear wheel for arresting or collapsing the scooter. Because with one hand the unlocking of the collapsing mechanism is carried out, and the scooter has to be held with the other hand so that it does not fall over. In addition, the latch is often force-fit, so that the user of the scooter must apply a high force or clamping force.

When the user loads the deck of such a scooter and holds a bar of the scooter, a load path runs through an obliquely arranged strut towards the deck and over the bar towards the front axle of the scooter. Since the collapsing mechanism for unlocking and collapsing the scooter is arranged in the area of the obliquely arranged strut, this mechanism must be designed to be very robust. The very indirect load paths associated with the arrangement of the mechanism in the area of the obliquely extending strut also ensure a comparatively high error-proneness, a high excess weight and low tolerances. This is a disadvantage.

Furthermore, such a scooter is difficult to carry in a folded state, because the scooter can easily swing with its entire weight around a longitudinal axis of the handlebar. Furthermore, it is also not possible to pull the collapsed scooter behind you if the scooter has only one front wheel. Because even when trying to pull the scooter with only one front wheel behind you, the scooter would tilt around the longitudinal axis of the handlebar.

### BRIEF DESCRIPTION OF THE DRAWINGS

FIG. 1 shows in perspective a scooter with four wheels, wherein an actuation element for releasing a locking device of the scooter is arranged on a grip part of a steering column of the scooter.

FIG. 2 shows the grip part in an enlarged detail view.

### DETAILED DESCRIPTION

The disclosure relates to a scooter with a deck, by means of which a contact surface is provided for a user of the scooter in a functional position of the scooter. A front axle of the scooter has at least one front wheel, and a rear axle has at least one rear wheel. A steering column is used to transmit a steering motion to the at least one front wheel. An actuation element for releasing a locking device is arranged on the steering column. When the locking device is released, the scooter can be brought into a stowing position.

DE 10 2013 003 484 A1 describes a collapsible scooter with an electric drive motor. The scooter has a locking element for locking a folding joint in a state of use of the scooter and in a collapsed state of the scooter, which is connected to a release lever via a Bowden cable. The release lever is arranged on a bar of the scooter.

DE 102 04 478 A1 describes a scooter which comprises a handlebar unit, a front part with two front wheels and a rear part with one rear wheel. An unlocking lever is arranged on the handlebar unit. If the unlocking lever is moved downwards, an unlocking of the handlebar unit opposite the front part is achieved. At the same time an unlocking between the front part and rear part is created. A flexible spring then pivots the rear part about an axis towards the front part. In this way, the scooter can be converted from a scooter state to a caddy state. In the caddy state, the front part and the rear part are inclined towards the ground and against each other and they are supported on the ground by their wheels.

Such a scooter is relatively expensive due to the provision of the front part with the front wheels and the rear part with the rear wheel separate from the front part.

In addition, scooters with a front wheel and a rear wheel are commercially available, which can be folded or collapsed to facilitate transport in a motor vehicle or means of public transport. The collapsing of such a scooter also ensures that the space required to store the scooter at home by the user of the scooter is reduced. A collapsing mechanism to be actuated for collapsing is usually arrested near the front wheel of the scooter. After unlocking the collapsing mechanism, a deck of the scooter can be pivoted around an axis of rotation and folded up towards the handlebar. It is advantageous if the axis of rotation is as close as possible to the front wheel.

A disadvantage of such a scooter is the fact that the clamping mechanism or unlocking mechanism can only be operated when the user of the scooter bends down. In addition, both hands are required in such a scooter with a front wheel and a rear wheel for arresting or collapsing the scooter. Because with one hand the unlocking of the collapsing mechanism is carried out, and the scooter has to be held with the other hand so that it does not fall over. In addition, the latch is often force-fit, so that the user of the scooter must apply a high force or clamping force.

When the user loads the deck of such a scooter and holds a bar of the scooter, a load path runs through an obliquely arranged strut towards the deck and over the bar towards the front axle of the scooter. Since the collapsing mechanism for unlocking and collapsing the scooter is arranged in the area of the obliquely arranged strut, this mechanism must be designed to be very robust. The very indirect load paths associated with the arrangement of the mechanism in the area of the obliquely extending strut also ensure a comparatively high error-proneness, a high excess weight and low tolerances. This is a disadvantage.

Furthermore, such a scooter is difficult to carry in a folded state, because the scooter can easily swing with its entire weight around a longitudinal axis of the handlebar. Furthermore, it is also not possible to pull the collapsed scooter behind you if the scooter has only one front wheel. Because even when trying to pull the scooter with only one front wheel behind you, the scooter would tilt around the longitudinal axis of the handlebar.

The object of the present disclosure is therefore to create a particularly easily stowable scooter and to provide a corresponding method for operating a scooter.

This object is achieved by a scooter with the features of claim 10 and by a method with the features of claim 18. Advantageous embodiments with expedient developments of the disclosure are specified in the dependent claims.

The scooter according to the disclosure comprises a deck, by means of which a contact surface for a user of a scooter in a functional position of the scooter is provided. A front axle of the scooter has at least one front wheel. A rear axle of the scooter has at least one rear wheel. A steering column of the scooter is intended for transmitting a steering motion to the at least one front wheel. An actuation element for releasing a locking device is arranged on the steering column. With the locking device released, the scooter can be placed in a stowing position. In the stowing position of the scooter, the rear axle is moved together with the deck around an axis of rotation towards the steering column. Here, in the stowing position, a distance between the rear axle and the front axle is equal to a distance existing in the functional position between the rear axle and the front axle. The deck does therefore not fold or collapse by itself when it is folded up. The scooter can be stowed very easily by moving the rear axle together with the deck around the axis of rotation towards the steering column in order to move the scooter into the stowing position. In addition, the scooter is very compact in its stowing position. This applies in particular if, in the stowing position, the contact surface of the deck is aligned substantially parallel to the steering column. With regard to a large compactness of the scooter in the stowing position, it can also be advantageous to provide that the deck and/or the rear axle in the stowing position of the scooter lie at least partially against the steering column.

Furthermore, by moving the rear axle together with the deck around the axis of rotation on the steering column, it can be achieved that the axis of rotation is particularly close to a center of the at least one front wheel. As a result, a very direct flow of force is achieved when driving the scooter, which unloads the locking device. The locking device therefore needs to be designed to be less robust as it is the case with an arrangement of a locking device on an obliquely extending strut, which leads from a deck of the scooter to the handlebar of the scooter. The relief of the locking device also makes it possible for the locking device to be very easily actuated, operated or released by means of the actuation element spaced from the locking device, namely arranged on the steering column.

The scooter is particularly easy to steer because for transmitting the steering motion to the at least one front wheel, the handlebar of the steering column can be rotated around a longitudinal axis of the steering column by means of a steering handle.

It is also advantageous that the actuation element is arranged on the steering handle. At least one hand of the user can then remain on the steering handle to release the locking device and move the scooter into the stowing position. The user of the scooter therefore does not need to change his posture and in particular does not need to bend down in order to cause the release of the locking device.

By actuating the actuation element, a motion device can be activated by means of which the scooter can be moved from the functional position to the stowing position. Such a spring-loaded motion device, for example in the functional position, makes the collapsing of the scooter, i.e. bringing the scooter from the functional position to the stowing position, particularly easy and convenient. Because activating the motion device causes the rear axle to move together with the running board around the axis of rotation towards the steering column.

Additionally, it can be provided that a steering motion of the scooter can be achieved by changing the inclination of the deck. This provides a particularly high flexibility for the user when steering the scooter.

In particular, the steering handle can be formed as a loop-like grip part, which comprises a transverse spar and two struts connecting the transverse spar to the handlebar. The scooter can be lifted or pulled particularly easily by such a grip part. In particular, such a grip part can be held by the user on the transverse spar if the user wishes to pull the scooter, which is moved into its stowing position, behind him or her like a trolley case.

Preferably, it is intended that the actuation element is located on the transverse spar of the grip part, for example on a lower side of the transverse spar.

It has also been shown to be advantageous if the weight of the deck and rear axle is less than the weight of the steering column and front axle. This ensures that most of the scooter's weight is concentrated on the area of the front axle when the scooter is in its functional position. Due to this weight distribution, a folding up of the deck together with the rear axle, in particular the folding up caused by the motion device, can be realized very easily. It is also advantageous in the stowing position of the scooter, when a comparatively light deck and a comparatively light rear axle are moved towards the steering column. In this way, swaying of the scooter caused by the weight of the deck and the rear axle, i.e. motion around the roll axle of the scooter, can be avoided to a particularly large extent if the user pulls the scooter, which has been placed in its stowing position, behind him or her like a trolley case.

In order to achieve a lightweight construction of the deck and thus with a particularly low weight, the deck can be made of a fiber-reinforced plastic, such as a glass fiber reinforced plastic and/or a carbon fiber reinforced plastic. An especially low weight of the deck can also be ensured by manufacturing the deck from wood.

Furthermore, in contrast to a rigid deck made of metal, such materials give the deck particularly good resilient properties, thus the comfort of the user when driving the scooter is improved. Furthermore, due to the springy properties of the deck, there is no need for a separate suspension of the chassis of the scooter, and yet a high level of comfort is achieved when using the scooter.

It has been shown to be further advantageous if at least one front wheel can be driven by means of at least one electric motor. Because then the user does not need to move the scooter with muscle power alone.

Preferably, an electrical energy storage, formed to supply the at least one electric motor, is located on the steering column. Because this contributes to the fact that most of the weight of the scooter is concentrated on the front axle. The same applies analogously if the at least one electric motor formed for driving the at least one front wheel is arranged on the front axle.

Preferably the front axle has two front wheels. This ensures on the one hand a good stability of the scooter. Furthermore, it is very easy to achieve so that the user can pull the scooter placed in its stowing position like a trolley or trolley case behind him or her. If the scooter has two front wheels, in particular, a respective electric motor can be provided for driving the respective front wheel.

Alternatively, but preferably in addition, the rear axle of the scooter can have two rear wheels. On the one hand, the stability of the scooter is very high when the user of the scooter is standing on the deck. A tilting of the scooter is then easily and safely avoided. In addition, the user can then simply park the scooter in its functional position without having to lean it and without the need for the scooter to be fitted with a stand for this purpose.

It has also proved to be advantageous if a braking device is arranged on the rear axle. For example, by actuating a brake pedal, the user can cause at least one rear wheel of the scooter to brake. In this case, pressing down the brake pedal can cause a pulling of a cable pull or the like, which in turn pulls a brake pad of the braking device against a brake disc of the braking device. In this way, a safe and comfortable braking of the scooter can be achieved in a particularly simple manner.

Preferably, the deck has a central area surrounding the contact surface and at least one end area adjacent to the central area. The at least one end area rises towards the rear axle and/or towards the front axle. In particular, a first end area can rise towards the rear axle and a second end area can rise towards the front axle. This ensures that the central area of the deck is relatively low compared to the front axle and the rear axle. This results in a low center of gravity of the scooter, which in turn improves the driving characteristics of the scooter.

Finally, it has been shown to be advantageous to have an indicating apparatus on the steering column to show at least one running parameter of the scooter. The indicating apparatus can in particular comprise a plurality of light-emitting diodes or the like and can, for example, enable the display of a driving speed, a state of charge of an electrical energy storage of the scooter, a range of the scooter given during the electrical driving operation of the scooter, navigation instructions and the like. This is also beneficial for a comfortable use of the scooter.

In the method of operating a scooter according to the disclosure, which comprises a deck providing a contact surface for a user of the scooter in a functional position, a front axle having at least one front wheel, a rear axle having at least one rear wheel, and a steering column for transmitting a steering motion to the at least one front wheel, a locking device is released by actuating an actuation element arranged on the steering column. When the locking device is released, the scooter is placed in a stowing position. For transmitting the steering motion to the at least one front wheel, the handlebar of the steering column is rotatable about a longitudinal axis of the steering column by means of a steering handle, and the actuation element arranged on the steering handle is actuated. For moving the scooter into the stowing position, the rear axle together with the deck is pivoted around an axis of rotation and moved towards the steering column. In the stowing position of the scooter, a distance between the rear axle and the front axle is equal to an existing distance between the rear axle and the front axle in the functional position. The deck does therefore not fold or collapse by itself when it is folded up. By actuating the actuation element, a motion device is activated. Activating the motion device causes the rear axle to move together with the deck around the axis of rotation towards the steering column. This type of operation makes the scooter particularly easy to stow, respectively to collapse or fold, and thus to move from the functional position into the stowing position.

The disclosure also includes the combinations of the described embodiments.

The disclosure also includes developments of the method according to the disclosure, which include features such as those that were previously described in connection with the refinements of the scooter according to the disclosure. For this reason, the corresponding developments of the method according to the disclosure are not described again herein.

Exemplary embodiments of the disclosure are described below.

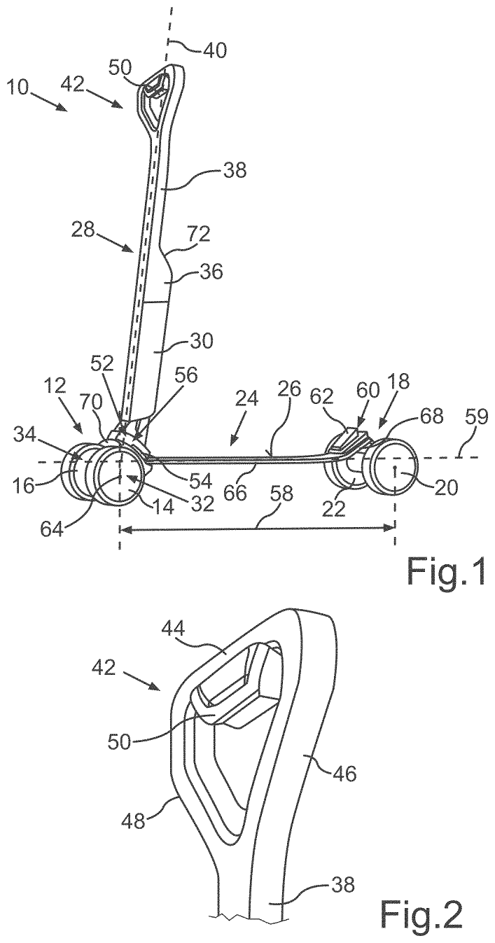

FIG. 1 shows in perspective a scooter with four wheels, wherein an actuation element for releasing a locking device of the scooter is arranged on a grip part of a steering column of the scooter.

FIG. 2 shows the grip part in an enlarged detail view.

The exemplary embodiments described below are preferred embodiments of the disclosure. In the embodiments, the components of the embodiments that are described respectively constitute individual features of the disclosure to be considered independently of each other and which individually also further develop the disclosure independently of each other, and are thus also to be considered part of the disclosure, both individually and in a combination that is different from the combination described. In addition, the embodiments described can also be complemented by further features of the disclosure, which have already been described.

In the figures, functionally identical elements are denoted with the same reference characters.

In FIG. 1 a scooter 10 is shown in a perspective view, which presently comprises a front axle 12 with a first front wheel 14 and a second front wheel 16 and a rear axle 18 with a first rear wheel 20 and a second rear wheel 22. A deck 24 of the scooter 10 has an upper side 26 on which a user of the scooter 10 can stand in the functional position of the scooter 10 shown in FIG. 1. The scooter 10 has a steering column 28 for transmitting a steering motion to the front wheels 14, 16. The scooter 10 is presently formed as an electromotively driven scooter 10. For this reason, an electrical energy storage in the form of a rechargeable battery 30 is arranged on the steering column 28. The battery 30 is used for supplying the respective electric motors 32, 34, which can be formed as wheel hub motors, for example. The electric motors 32, 34 are formed for driving the front wheels 14, 16. At least one electronic module 36 or a control unit for controlling the electric motors 32, 34 and/or for monitoring a state, in particular a state of charge, of the battery 30 is also arranged on the steering column 28. The battery 30 can be arranged underneath the electronic module 36, which is advantageous in order to keep the center of gravity of the scooter 10 as low as possible.

On the steering column 28, located above the electronic module 36 (and thus also above the battery 30), a graphical user interface or display apparatus 72 is preferably arranged. This indicating apparatus 72 is capable of indicating running parameters of the scooter 10 such as a driving speed, a state of charge of the battery 30, a remaining range of the scooter 10 or the like. It may also be provided that the user of the scooter 10 can be given navigation instructions via the indicating apparatus 72.

The steering column 28 comprises a handlebar 38 which can be turned around a longitudinal axis 40 of the steering column 28 to transmit a steering motion to the front wheels 14, 16. For turning the handlebar 38 and thus for steering, the steering column 28 comprises a steering handle, which is formed, for example, as a loop-shaped grip part 42.

The grip part 42 is illustrated enlarged in FIG. 2. Accordingly, the grip part 42 comprises a transverse spar 44 and two struts 46, 48, which connect the transverse spar 44 with the handlebar 38.

An actuation element 50 is arranged on the transverse spar 44, which serves to release a locking device 52 of the scooter 10. The locking device 52 is shown here only with regard to its positioning in the area of the front axle 12. Releasing of the locking device 52 causes the scooter 10 to be moved to a stowing position in which the scooter 10 is collapsed or folded. When collapsing the scooter 10, the rear axle 18 together with the deck 24 is pivoted around an axis of rotation 54 and moved towards the steering column 28. This folding up or pivoting of the deck 24 together with the rear axle 18 about the axis of rotation 54 is also effected by actuating the actuation element 50. Actuating the actuation element 50 activates a motion device 56, which is not shown in detail here, which guides the deck 24 towards the handlebar 38. A distance 58 between the rear axle 18 and the front axle 12 remains constant, so the deck 24 does therefore not fold or collapse by itself when it is folded up. The motion device 56 is also shown here only with regard to its positioning in the area of the front axle 12.

The scooter 10 combines the excellent characteristics of a two-wheeled scooter, in particular an electric scooter, with a bar having the characteristics of a skateboard with four wheels, in which the steering can be effected by varying an inclination of the deck 24, i.e. tilting the deck 24 about its roll axis 59. The scooter 10 can therefore be steered by turning the handlebar 38 around the longitudinal axis 40 of the steering column 28 using the grip part 42. Additionally or alternatively, the scooter 10 can be steered by changing the inclination of the deck 24.

The positioning of the battery 30 and the electric motors 32, 34 in the area of the front axle 12 or above the front axle 12 means that most of the weight is concentrated on the front axle 12. Furthermore, the deck 24 is preferably conceptualized as a lightweight construction, for example by using a fiber-reinforced plastic and/or wood as material.

The non-driven rear wheels 20, 22 of the scooter 10 can be braked mechanically by means of a braking device 60, which is arranged on the rear axle 18, and of which only a foot-operated brake pedal 62 is shown. Despite the provision of the braking device 60 on the rear axle 18, the deck 24 together with the rear axle 18 can be easily pivoted around the axis of rotation 54 and thus folded upwards or moved towards the steering column 28 when the scooter 10 is to be moved into its stowing position.

The easy moving of the scooter 10 into the stowing position is further enhanced by the fact that the axis of rotation 54 is arranged particularly close to a center 64 of the respective front wheel 14, 16. This facilitates the automatic folding up of the deck 24 towards the steering column 28, in this case by means of the motion device 56. Thanks to the optimized weight distribution, in which the weight of the deck 24 and the rear axle 18 is significantly lower than the weight of the steering column 28 and the front axle 12, the automatic folding up of the deck 24 is particularly easy to achieve.

In addition, the proximity of the axis of rotation 54 to the center 64 ensures a very direct flow of force when driving, i.e. when the weight of the user of the scooter 10 rests on the deck 24 and to a lesser extent on the steering column 28. The locking device 52 is also unloaded by the direct flow of force. This enables or facilitates the actuation or operation of the locking device 52 by means of the actuation element 50 located on the steering column 28, present on the grip part 42.

The unlocking of the scooter 10 is thus achieved by actuating the actuation element 50 formed on the bar or grip part 42 or on such a handlebar handle. In addition, actuating the actuation element 50 results in the deck 24 being guided to the handlebar 38 by the motion device 56 or such a force element. The user does not need to bend down for this, however, but can stand next to the scooter 10 and simply actuate the actuation element 50, for example, by moving the actuation element 50 towards the transverse spar 44 of the grip part 42. After folding up the deck 24 and thus moving the scooter 10 into its stowing position, the user can grab the scooter 10 by the grip part 42 and pull it behind him or her like a trolley case.

The running board 24 presently has a central area 66 which comprises the contact surface and a first end area 68 which is connected to the central area 66. This first end area 68 rises towards the rear axle 18. In this end area 68 there is also the brake pedal 62, which is therefore also inclined in relation to the roll axis 59. The deck 24 comprises a further end area 70 adjoining the central area 66, which rises towards the front axle 12. Due to these inclined end areas 68, 70, the central area 66 of the deck 24 is arranged comparatively low-lying. This leads to a large ground proximity of the central area 66 and thus to a low-lying center of gravity of the scooter 10.

The axis of rotation 54 about which the central area 66 and the rear end area 68 of the deck 24 are pivoted when the scooter 10 is moved into its stowing position can be located at the point where the central area 66 adjoins the front end area 70, depending on the design of the collapsing mechanism of the scooter 10. The axis of rotation 54 can therefore be located in the area of a kink in the deck 24 formed by the front end area 70 and the central area 66.

Overall, the examples show how the disclosure provides an automatic collapsing function for an individual means of transportation in the form of the scooter 10.

1.-9. (canceled)

10. A scooter comprising a deck, a front axle, a rear axle, a steering column, a motion device and a locking device, wherein the scooter is configured to:
operate in a functional position;
transmit, by the steering column, a steering motion to the front axle, wherein the front axle comprises a front wheel, and wherein the steering column comprises a handlebar and a steering handle that comprises an actuation element;
actuate the actuation element;
release, by the actuation element, the locking device;
activate, by the locking device, the motion device;
guide, by the motion device, the deck and the rear axle to move together about an axis of rotation towards the handlebar, wherein the rear axle comprises a rear wheel; and
switch to a stowing position,
wherein the deck comprises a contact surface for a user of the scooter,
wherein a distance between the rear axle and the front axle in the functional position is a predetermined distance,
wherein a distance between the rear axle and the front axle in the stowing position is the predetermined distance,
wherein the deck remain spreading when it is guided towards the handlebar, and
wherein the handle bar is rotatable about a longitudinal axis of the steering column by the steering handle.

11. The scooter according to claim 10, wherein the steering motion of the scooter is effected by an inclination of the deck.

12. The scooter according to claim 10, wherein the steering handle comprises a transverse spar and two struts that connect the transverse spar to the handlebar.

13. The scooter according to claim 10, wherein the deck and the rear axle are made of fiber-reinforced plastic and/or wood, and wherein weight of the deck and the rear axle is less than weight of the steering column and the front axle.

14. The scooter according to claim 10 further comprising an electric motor and an electric energy storage, wherein the scooter is further configured to:
drive, by the electric motor, the front wheel of the front axle; and
supply, by the electric energy storage, the electric motor,
wherein the electric energy storage is on the steering column.

15. The scooter according to claim 10, wherein the front axle comprises two front wheels, and wherein the rear axle comprises a braking device and two rear wheels.

16. The scooter according to claim 10, wherein the deck comprises a central region and an end region adjoining the central region, wherein the central region comprises the contact surface, and wherein the end region rises towards the rear axle or the front axle.

17. The scooter according to claim 10, wherein the steering column comprises a display device for displaying a running parameter of the scooter.

18. A method of operating a scooter, wherein the scooter comprises a deck, a front axle, a rear axle, a steering column, a motion device and a locking device, the method comprising:
operating in a functional position;
transmitting, by the steering column, a steering motion to the front axle, wherein the front axle comprises a front wheel, and wherein the steering column comprises a handlebar and a steering handle that comprises an actuation element;
actuating the actuation element;
releasing, by the actuation element, the locking device;
activating, by the locking device, the motion device;
guiding, by the motion device, the deck and the rear axle to move together about an axis of rotation towards the handlebar, wherein the rear axle comprises a rear wheel; and
switching to a stowing position,
wherein the deck comprises a contact surface for a user of the scooter,
wherein a distance between the rear axle and the front axle in the functional position is a predetermined distance,
wherein a distance between the rear axle and the front axle in the stowing position is the predetermined distance,
wherein the deck remain spreading when it is guided towards the handlebar, and
wherein the handle bar is rotatable about a longitudinal axis of the steering column by the steering handle.
